(19) United States
(12) Patent Application Publication
(10) Pub. No.: US 2008/0111741 A1
(43) Pub. Date: May 15, 2008

(54) Redundant mobile antenna system and method for operating the same

(75) Inventors: Sean S. Lee, Rockville, MD (US); Su Zhang, Bethesda, MD (US)

Correspondence Address: THE DIRECTV GROUP, INC.;PATENT DOCKET ADMINISTRATION, CA / LA1 / A109, P O BOX 956, EL SEGUNDO, CA, 90245-0956, US

(73) Assignee: The DirecTV Group, Inc.

(21) Appl. No.: 11/595,330

(22) Filed: Nov. 10, 2006

(51) Int. Cl. G01S 3/16; H01Q 3/00; G01S 3/28

(52) U.S. Cl. 342/383; 342/359

(57) ABSTRACT

A communication system 10 includes a satellite 18 that broadcasts communication signals to a first antenna 28A and a second antenna 28B. The antenna forms a first signal and a second signal and is provided to a combiner 102. The combiner 102 is coupled to the antennas 28A and 28B and combines the first portion of the first signal and a second portion of the second signal to form an output signal 152. The output signal is received by the receiving unit 28A-28n and utilized by the receiving unit to display or otherwise use the output signal.

### TECHNICAL FIELD

The present invention relates generally to a satellite communication system, and, more particularly, to a satellite information receiving system having redundant antennas to improve the quality of the signals therein in a vehicle.

### BACKGROUND

The statements in this section merely provide background information related to the present disclosure and may not constitute prior art.

Satellite television has become increasingly popular due to its wide variety of programming. Current DIRECTV systems employ an antenna that is fixed to a structure. The antenna is pointed once and secured into place. Entertainment in automobiles, such as DVD players, has become increasingly popular. It would be desirable to provide a satellite television system for a vehicle so that a wide variety of programming may be enjoyed by the passengers. One problem with mobile systems is that the satellite signals may be blocked due to various structures and trees.

It would be desirable to provide a system for various types of vehicles that reduces the reception blockage and provides an improved signal to the users.

### SUMMARY

In one aspect of the invention, a vehicle includes a plurality of spaced-apart antennas and a combiner coupled to the space-apart antennas. The combiner combines a portion of the first signal and a portion of the second signal to form an output signal. A receiving unit receives the output signal. It should be noted that several signals may be combined.

Another feature of the invention is that a train may incorporate the communication system. On a train, the antennas may be spaced significantly apart to avoid interruption due to bridges, tunnels, and various other obstructions.

Another of the disclosure includes a communication system that includes a first satellite tracking antenna receiving a satellite signal forming a first signal, a second satellite tracking antenna spaced apart from the second antenna forming a second signal from the satellite signal. A combiner is coupled to the spaced-apart antennas and combines a first portion of the first signal and a second portion of the second signal to form an output signal. A receiving unit is also coupled to receive the output signal.

Another feature of the invention is a method that comprises receiving a satellite signal at a first antenna, receiving a satellite signal at a second antenna spaced apart from the first antenna and combining a first portion of the first signal and a second portion of the second signal to form an output signal. The method further includes communicating the output signal to a receiving unit.

In yet another feature of the invention, a method comprises receiving a plurality of packets from a plurality of spaced-apart antennas, determining valid packets from the plurality of packets and combining the valid packets from the plurality of packets to form an output stream of packets.

Further areas of applicability will become apparent from the description provided herein. It should be understood that the description and specific examples are intended for purposes of illustration only and are not intended to limit the scope of the present disclosure.

### BRIEF DESCRIPTION OF DRAWINGS

The drawings described herein are for illustration purposes only and are not intended to limit the scope of the present disclosure in any way.

FIG. 1 is a system level view of a satellite broadcasting system according to the disclosure of the invention.

FIG. 2 is a block diagrammatic view of a receiving unit according to the present invention.

FIG. 3 is a block diagrammatic view of the system according to the disclosure.

FIG. 4 is a plot of a packet received by the system.

FIG. 5 is a block diagrammatic view of the second aspect of the disclosure.

FIG. 6 is a flow chart illustrating one method for operating the disclosure.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The following figures are described with respect to a mobile satellite television system. Although not limited thereto, the present system may be implemented in various types of vehicles including SUVs, vans, recreational vehicles, ships, trains, airplanes, buses or other systems.

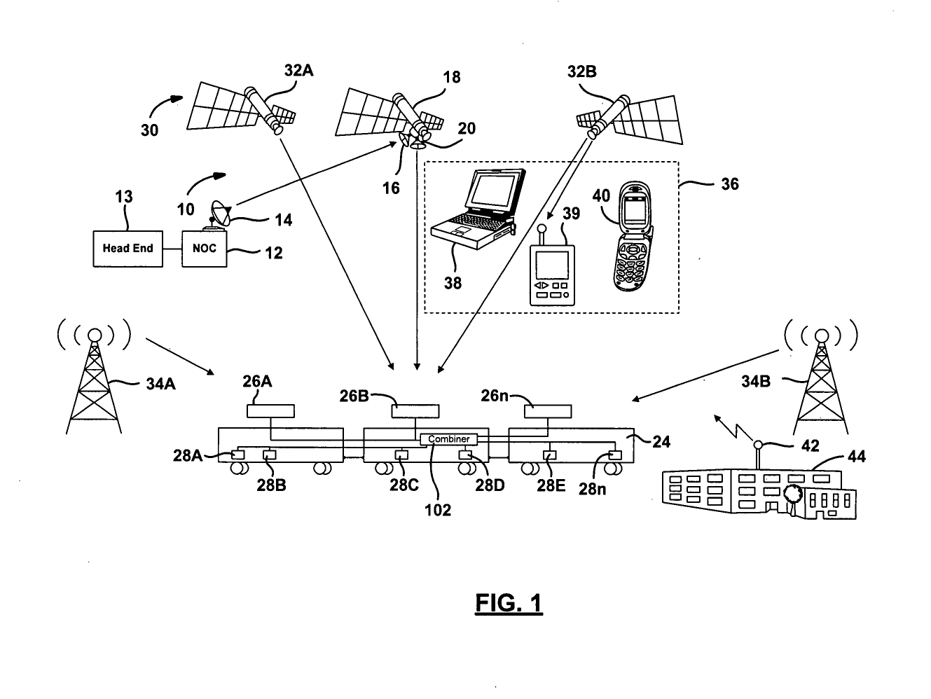

Referring now to FIG. 1, a satellite television broadcasting system 10 is illustrated. The satellite television broadcasting system 10 includes a network operations center 12 that generates wireless signals through a transmitting antenna 14 which are received by receiving antenna 16A-n of a satellite 18. The wireless signals, for example, may be digital signals such as digital television, audio or data signals. Transmitting antenna 20 generates signals directed to various receiving systems including stationary systems such as those in the home as well as mobile receiving systems 22. The wireless signals may have various types of information associated with them including location information. The wireless signals may also have various video and audio information associated therewith. As illustrated, the mobile receiving system 22 is disposed within a vehicle 24. As mentioned above, the vehicle 24 may include various types of vehicles including SUVs, vans, buses, ships, trains, airplanes, and other vehicles in which more than one satellite may be used.

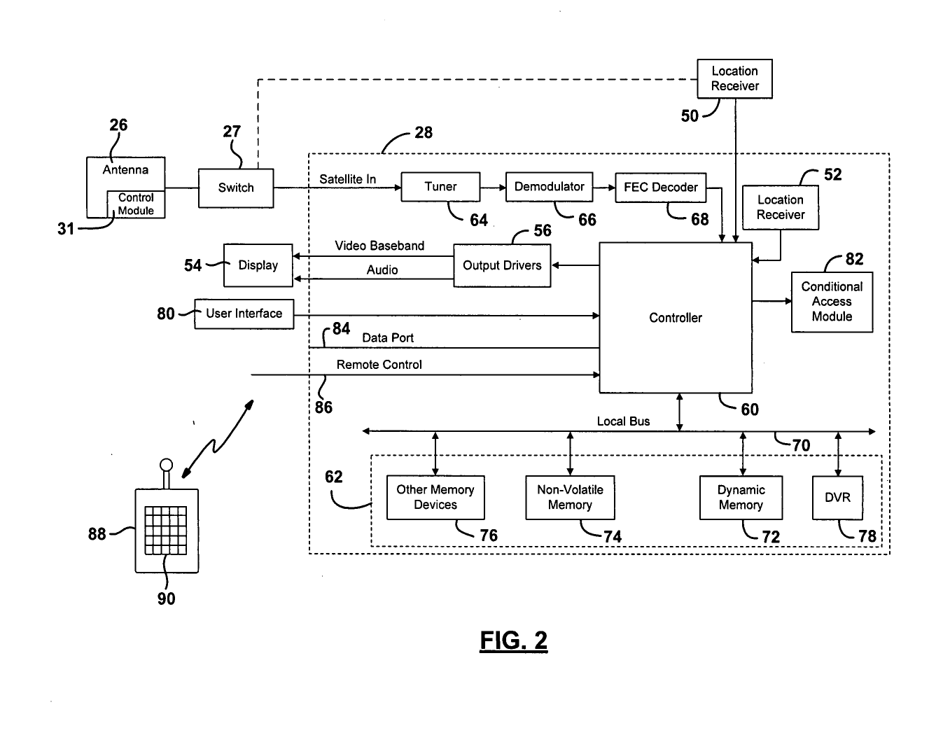

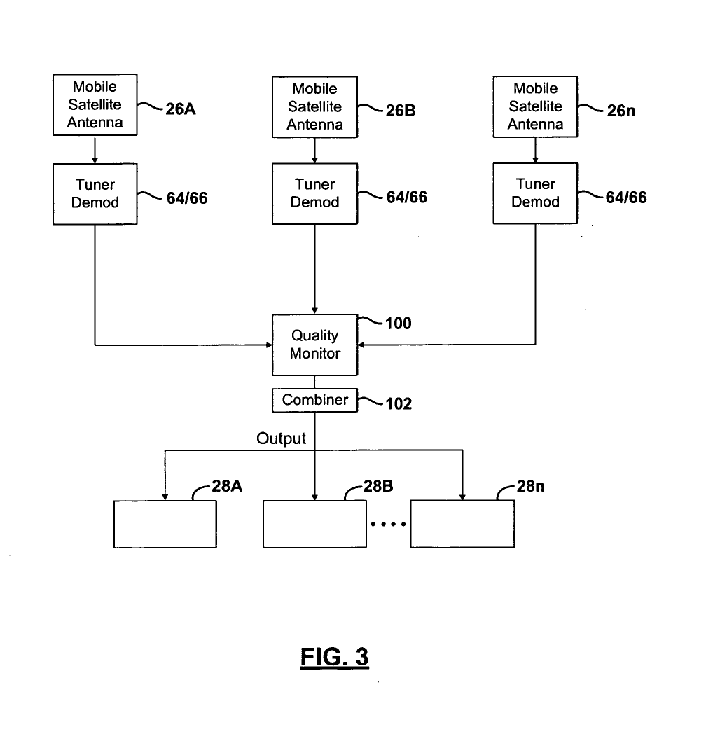

The mobile receiving system 22 and the vehicle 24 therein include multiple and receiving antennas 26A-26n. Various numbers of antennas 26A-26n may be used depending on the desired redundancy. More antennas may produce improved results if they are spaced apart enough. Each of the antennas 26A-26n is coupled to a combiner 102. The combiner has outputs coupled to a respective mobile receiving unit 28A-28n. Depending on the type of vehicle 24, various numbers of mobile receiving units 28 will be provided. For a cruise ship, the mobile receiving units may be located in each cabin. For a bus, train or airplane, the mobile receiving units 28 may be located in a seatback or the like. A controller such as a microprocessor, discrete circuit, ASIC or the like may be provided in combiner 102 to control the switching of the inputs and outputs. The mobile receiving unit 28 and the combiner 27 will be further described below in FIGS. 2 and 3, respectively.

The system 10 may also receive location signals from a GPS system 30 that includes a first satellite 32A and a second satellite 32B. Although only two satellites are shown, a typical GPS system includes several satellites, several of which may be in view at any particular time. Triangulation techniques may be used to determine the elevation, latitude and longitude of the system. A locating system may also include cellular towers 34A and 34B that may be used by the mobile receiving system 22 to determine a location. Cellular phones typically include a GPS locating system. As the vehicle 24 moves about, the exact coordinates in latitude and longitude may be used to determine the proper designated marketing area for local television and broadcasting.

The present disclosure may also be used for displaying various wireless information on a personal mobile device 36, such as a laptop computer 38, a personal digital assistant 39, and a cellular telephone 40. It should be noted that these devices and the automotive-based devices may also receive wireless signals having various types of information associated therewith from the cellular towers 34A and 34B. Other types of information may be broadcast from various other types of broadcasting areas such as an antenna 42 on a building 44. The building 44 may be various types of buildings such as a store and the wireless information transmitted from the antenna 42 may be advertising information. The wireless signals may include location information transmitted therewith. As will be described below, the information may be coded digitally into the signals. Thus, by reviewing the location information, signals appropriate for the location of the mobile devices may be displayed on the various devices.

Referring now to FIG. 2, a receiving system 22 is illustrated in further detail. Only one antenna 26 and one receiving device 28 are illustrated for simplicity. Many of both may be present. Antenna 26 may be various types of antennas including a tracking antenna that moves or rotates to track the relative movement of the satellite or other transponding devices with respect to the vehicle. The antenna 26 may also be an electronic antenna. The antenna 26 may two-way communicate information to the mobile receiving unit 28 regarding its status such as a locked-on state, tuning state, seeking state or the like.

The antenna 26 may include a control module 27 that controls the communication with the receiving unit 28 and controls the movement to track the desired satellite.

The mobile receiver unit 28 may be coupled to antenna 26 with a two-way communication channel such as a wire or a wireless system. The mobile receiving unit 28 may also include a location receiver 52 integrated therein. The location receiver 52 may be a GPS receiver. In a preferred embodiment, only one location receiver 50, 52 may be provided in the system. However, the location receiver 50, 52 may be part of the vehicle 24 or may be part of or in communication with the mobile receiving system 22. The controller 60 may be coupled directly to location receiver 52 and/or location receiver 50. The mobile receiving unit 28 is in communication with a display 54. The display 54 may be incorporated into the device 36 or within the vehicle 24. The display 54 may include output drivers 56 used for generating the desired audio and video outputs suitable for the particular display 54.

A controller 60 may be a general processor such as a microprocessor. The controller 60 may be used to coordinate and control the various functions of the receiving unit 28. These functions may include a tuner 64, a demodulator 66, a forward error correction decoder 68 and any buffers and other functions. The tuner 64 receives the signal or data from the individual channel. The demodulator 66 demodulates the signal or data to form a demodulated signal or data. The decoder 68 decodes the demodulated signal to form decoded data or a decoded signal. The controller 60 may be similar to that found in current DirecTV set top boxes which employ a chip-based multifunctional controller.

The controller 60 may include or be coupled to a local bus 70. The local bus 70 may be used to couple a dynamic memory 72 such as RAM which changes often and whose contents may be lost upon the interruption of power or boot up. The bus 70 may also be coupled to a non-volatile memory 74. The non-volatile memory may be an in-circuit programmable type memory. One example of a non-volatile memory is an EEPROM. One specific type of EEPROM is flash memory. Flash memory is suitable since it is sectored into blocks of data segments that may be individually erased and rewritten.

Other memory devices 76 may also be coupled to local bus 70. The other memory devices may include other types of dynamic memory, non-volatile memory, or may include such devices such as a digital video recorder. The display 54 may be changed under the control of controller 60 in response to the data in the dynamic memory 72 or non-volatile memory 74. A digital video recorder (DVR) 78 may also be coupled to the local bus as a memory for storing programming thereon.

The controller 60 may also be coupled to a user interface 80. User interface 80 may be various types of user interfaces such as a keyboard, push buttons, a touch screen, a voice activated interface, or the like. User interface 80 may be used to select a channel, select various information, change the volume, change the display appearance, or other functions. The user interface 80 is illustrated as part of the mobile receiving unit. However, should the unit be incorporated into a vehicle, the user interface 80 may be located external to the mobile receiving unit such as dial buttons, voice activated system, or the like incorporated into the vehicle and interface with the mobile receiving unit.

A remote control input 86 in communication with a remote control 88 having a keypad or other user interface may be used. The remote control 88 communicates control signals to the remote control input 86, which in turn provides various data to the controller 60.

A conditional access module card 82 (CAM) may also be incorporated into the mobile receiving unit. Access cards such as a conditional access module (CAM) cards are typically found in DirecTV units. The access card 82 may provide conditional access to various channels and wireless signals generated by the system. Not having an access card or not having an up-to-date access card 66 may prevent the user from receiving or displaying various wireless content from the system.

An external data port 84 may be coupled to the controller 60 for transmitting or receiving information from a device. The receiving device is illustrated having a data port 84 that is coupled to antenna 26. The connection between the data port 84 and the antenna 26 may be one of a number of types of connections including an RS 232 type connection, a USB connection, a wired connection, a wireless connection or the like. A dedicated port from controller 60 may be used to communicate in addition to other data ports.

Referring now to FIG. 3, mobile satellite antennas 26A-26n may each be coupled to a tuner demodulator 64/66. As will be described below, the tuner demodulator circuit 64/66 is optional in some embodiments, since these functions may be moved into the receiving unit 28. In this example, a quality monitor 100 monitors the quality of the satellite signals. A combiner 102 receives the quality signals and combines the signals from the antennas having the highest quality. Monitoring the quality may take place in many forms including monitoring the RF signal prior to demodulation or monitoring the signal after tuning and demodulation. Various portions of the signals from different antennas may be combined to form an output signal that is provided to receiving units 28A-28n.

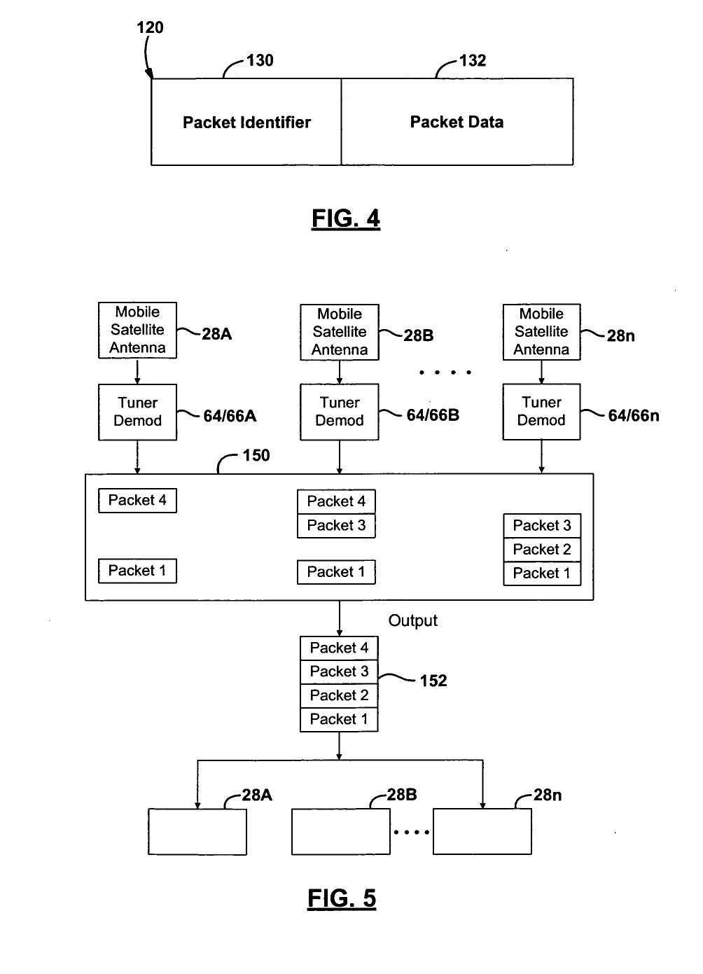

Referring now to FIG. 4, the signal from the satellites may be demodulated to a plurality of packets. Each packet 120 includes a packet identifier 130 and packet data 132.

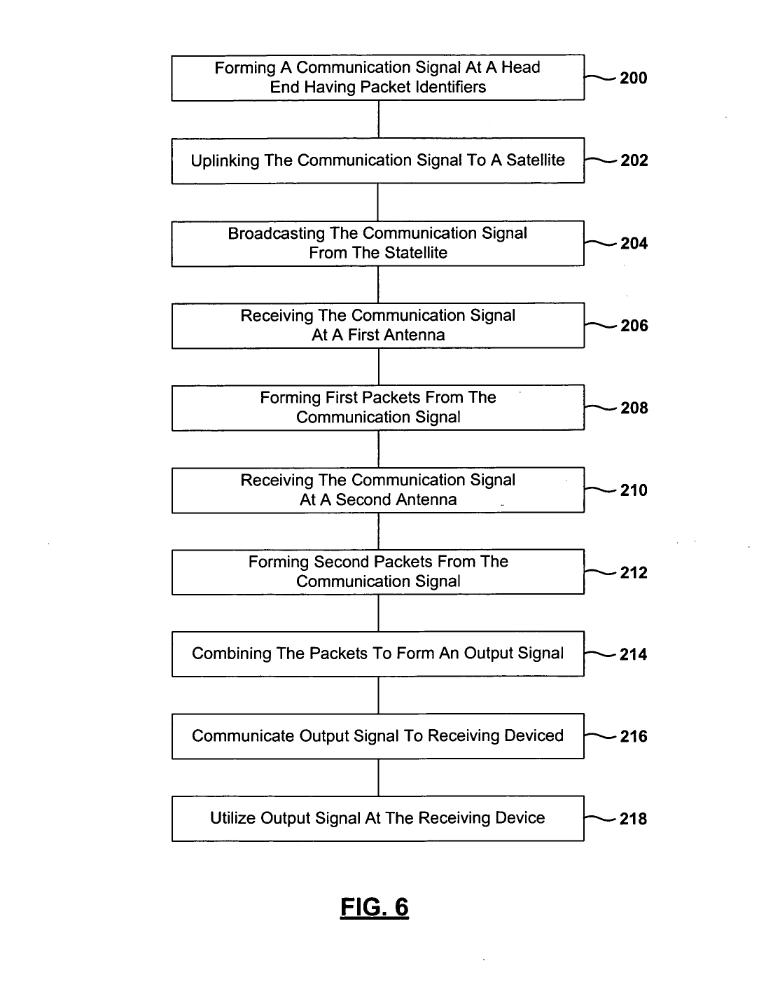

Referring now to FIG. 5, an alternative example is illustrated. The same satellite signal may be received at each of the mobile antennas 26A-26n. Although only two antennas have to be tuned to the same signal for the present invention to apply, it should be noted that other groups of antennas may be coupled to signals from other satellites. The teachings of this disclosure apply to the other groupings as well. That is, within each group with satellite antennas receiving the same signal, the method of combining may take place.

Once received at each antenna, the signals are then tuned and demodulated by tuner demodulator 64/66A-64/66n. The demodulator is used to obtain a packet stream having packets 120 as illustrated in FIG. 4. The packets 120 are provided to a packet combiner 150. The packet combiner 150 receives the various packets and reassembles the packets in order according to the packet identifier 130 of FIG. 4. As illustrated in the combiner, four packets are illustrated. From antenna 28A packets 1 and 4 were received. From antenna 28B packets 1, 3 and 4 were received. From antenna 28n packets 1, 2 and 3 were received. The packet combiner, due to the packet identifier, can reassemble the packets in order from packets that exist. Therefore, packet 1 could be chosen from any one of the antennas. Packet 2 may be only obtained from the output of antenna 28n. Packet 3 may be obtained from either the output of antenna 28B or the output of antenna 28n. Packet 4 may be used from the output of antenna 28A or 28B. As is illustrated in output signal 152 is generated and provided to the receiving units 28A-28n. Thus, it can be seen that the output packet stream 152 is a combination of valid packets. In this example, the validity of the packets may be determined by the packet identifier.

Referring now to FIG. 6, a method of operating a communication system according to the present invention is illustrated. In step 200, a communication signal is formed at a head end that may have packet identifiers (carrying through with the second example of the invention). Of course, those skilled in the art will recognize that the RF quality determination may be performed in a similar manner. In the following example, packets with packet identifiers are used.

In step 202, the communication signal is up-linked to the satellite with the packets. In step 204, the communication signal is broadcast by the satellite to various mobile receiving devices. The mobile receiving devices may be disposed within a vehicle such as a train. In step 206, the communication signal is received at a first antenna on a vehicle. In step 208, a first plurality of packets is formed from the communication signal. In step 210, the communication signal is received by a second antenna. In step 212, the communication signal is broken into packets. It should be noted that, although these steps are illustrated sequentially, they may be performed simultaneously. In step 214, the packets are combined to form an output signal by eliminating invalid packets. The output signal is communicated to a receiving device in step 216. In step 218, the output signal is utilized by the receiving device. This may include displaying the output signal in a video format, generating audible signals through a speaker, or a combination of both. The output signal may also be other types of data signals.

While the above example has been set forth with respect to a single signal, it should be noted that multiple satellite signals may be used in a similar manner. That is, because there are many users within a vehicle, each user may have the capability of selecting various channels each with its own packet stream.

What is claimed is:

1. A vehicle comprising:
a plurality of spaced apart antennas;
a combiner coupled to the spaced apart antennas, said combiner combining a portion of the first signal and a portion of the second signal to from an output signal; and
a receiving unit receiving the output signal.

2. A vehicle as recited in claim 1 wherein the plurality of antennas comprises a plurality of satellite tracking antennas.

3. A vehicle as recited in claim 1 wherein the plurality of satellite tracking antennas receive a satellite signal.

4. A vehicle as recited in claim 1 wherein the satellite signal comprise a packet identifier.

5. A vehicle as recited in claim 1 wherein the plurality of spaced apart antennas have a respective tuner and a respective demodulator.

6. A vehicle as recited in claim 1 wherein each demodulator generating a plurality of packets.

7. A vehicle as recited in claim 1 wherein said combiner combining the plurality of packets to form the output signal.

8. A vehicle as recited in claim 1 further comprising controlling a display in response to the output signal.

9. A vehicle as recited in claim 1 further comprising a quality monitor for an RF waveform.

10. A communication system for a vehicle comprising:
a first satellite tracking antenna receiving a satellite signal forming a first signal;
a second satellite tracking antenna spaced apart from the second antenna forming a second signal from the satellite signal;
a combiner coupled to the spaced apart antennas, said combiner combining a first portion of the first signal and a second portion of the second signal to from an output signal; and
a receiving unit receiving the output signal.

11. A communication system as recited in claim 10 wherein the first antenna comprises a first tuner and a first demodulator associated therewith, the second antenna comprises a second tuner and a second demodulator associated therewith.

12. A communication system as recited in claim 10 wherein first demodulator generates a first plurality of packets, and the second tuner generates a second plurality of packets.

13. A communication system as recited in claim 10 wherein said combiner combining the first plurality of packets and the second plurality of packets to form the output signal.

14. A communication system as recited in claim 10 further comprising a vehicle having the first antenna and the second antenna, the combiner and the receiving unit coupled thereto.

15. A communication system as recited in claim 14 wherein the vehicle comprises a bus.

16. A communication system as recited in claim 14 wherein the vehicle comprises a train.

17. A communication system as recited in claim 10 wherein the satellite signal comprise a packet identifier.

18. A communication system as recited in claim 10 wherein the plurality of spaced apart antennas have a respective tuner and a respective demodulator.

19. A communication system as recited in claim 10 wherein each demodulator generating a plurality of packets.

20. A communication system as recited in claim 10 further comprising a quality monitor an RF waveform.

21. A method comprising:
receiving a satellite signal at a first antenna;
receiving the satellite signal at the second antenna spaced apart from the first antenna;
combining a portion of the first signal and a portion of the second signal to from an output signal; and
communicating the output signal to a receiving unit.

22. A method as recited in claim 21 further comprising controlling a display associated with the receiving unit in response to the output signal.

23. A method as recited in claim 21 wherein the satellite signal has a packet identifier.

24. A method as recited in claim 23 wherein the step of combining is performed in response to the packet identifier.

25. A method comprising:
receiving a plurality of packets of an input signal from a plurality of spaced apart antennas;
determining valid packets from the plurality of packets; and
combining the valid packets from the plurality of antennas to from an output signal corresponding to the input signal.
